(19) United States
(12) Patent Application Publication
(10) Pub. No.: US 2024/0145723 A1
(43) Pub. Date: May 2, 2024

(54) METHOD OF MANUFACTURING LITHIUM BATTERY ELECTRODES WITH ENHANCED ELECTRICAL AND IONIC CONDUCTIVITY

(71) Applicants: VITZROCELL CO. LTD., Dangjin-si, Chungcheongnam-do (KR); MAKESENS INC., Calgary, Alberta (CA)

(72) Inventors: Simon PARK, Calgary, Alberta (CA); Chaneel PARK, Calgary, Alberta (CA); Hongseok CHO, Calgary, Alberta (CA); Jong-Song KIM, Dangjin-si, Chungcheongnam-do (KR); Kyoung-Soo PARK, Dangjin-si, Chungcheongnam-do (KR); Ji-Hoon KANG, Dangjin-si, Chungcheongnam-do (KR)

(21) Appl. No.: 18/282,260

(22) PCT Filed: Mar. 2, 2022
(86) PCT No.: PCT/KR2022/002930

§ 371 Date: Sep. 15, 2023

Related U.S. Application Data
(60) Provisional application No. 63/161,434, filed on Mar. 15, 2021.

(30) Foreign Application Priority Data
Dec. 23, 2021 (KR) 10-2021-0186472

(51) Int. Cl. H01M 4/62; H01M 4/04; H01M 10/052

(52) U.S. Cl. CPC H01M 4/625; H01M 4/0435; H01M 4/0471; H01M 4/622; H01M 10/052

(57) ABSTRACT

The present disclosure relates to a method of manufacturing a lithium battery electrode with enhanced electrical and ionic conductivity. The method includes applying photoelectromagnetic energy using IPL, laser, plasma or microwaves, thereby making it possible to apply energy to electrode nanocomposites including active materials, binders and conductive carbon additives.

### TECHNICAL FIELD

Disclosed herein is a method of manufacturing a lithium battery electrode, and specifically, a method of manufacturing a lithium battery electrode, including photoelectromagnetic treatment of carbon additives and polymer binders, removal of crystallinity in polymer binders, and electric or magnetic field induced alignment of carbon additive materials.

### BACKGROUND ART

Lithium batteries such as a lithium-ion battery have been widely used as a portable energy storage device thanks to their high energy density, high charging and discharging, and relatively long life expectancy, compared to other rechargeable batteries.

As demand for portable electronic devices and electric vehicles grows, demand for lithium batteries grows rapidly. In a lithium battery, an electrode consists of active materials, binders, and conductive carbon additives. Active materials provide sites for lithium-ion storage, and they may be conductive or non-conductive. Binders allow active materials to adhere to a current collector and mechanically hold them together in the electrode. Conductive carbon additives are mixed with the polymer binders and active materials to form a conductive network within the electrode, providing electrical conductivity.

Carbon black has been most commonly used as a conductive carbon additive thanks to its high surface area to volume ratio and relatively low cost. Recently, however, there is a trend towards carbon nanoparticles such as carbon nanotubes (CNTs), graphene, or graphene nanoplatelets (GNPs). Carbon nanoparticles have an exceptional aspect ratio and electrical conductivity compared to carbon black. Thus, the electrode requires less amounts of carbon additives (approx. 20 wt. %) to achieve desired electrical conductivity, resulting in an increase in the amount of active materials and subsequently the energy capacity of the cell. Carbon additives such as CNTs with a high aspect ratio also serve as a mechanical supporter in the electrode composite.

CNTs are well known for their high tensile strength, and they are often used for a polymer nanocomposite to enhance mechanical properties as well as electrical properties. As an electrode additive, CNTs prevent loss of electrical conductivity under mechanical stress and strain by maintaining conductive network within the electrode. Furthermore, CNTs secure the structural stability of the electrode by mechanically binding the polymeric binders and active materials [Gonzalez et al, 2017]. Various types of CNTs such as single-walled CNTs (SWCNTs), multi-walled CNTs (MWCNTs) or thin-walled CNTs (TWCNTs) form different configurations, thereby enhancing the electrical properties of lithium batteries.

Documents on the use of CNTs in lithium battery electrodes are presented as follows.

Carbon nanotube polymer lithium-ion battery and preparation method thereof, CN 2016/105 720 265 A

The document relates to a positive electrode made from cobalt acid lithium and nickel cobalt lithium manganate with a cladding of a carbon nanotube polymer. The process by which this battery is prepared is also described. According to the document, the battery including the positive electrode has increased gram capacity, energy density, increased residual capacity after repeated charging/discharging, and a longer cycle lifespan.

Hybrid nanofilament anode compositions for lithium-ion batteries, US 2017/9 564 629 B2

The document relates to a composition for a hybrid nanofilament electrochemical cell electrode. The composition consists of an aggregate of nanometer-sized electrically conductive filaments made of materials such as carbon nanotubes (CNTs) and carbon nanofibers (CNFs) that are interconnected and form a network of interconnected pores. The filaments are coated on a micro/nano-sized surface consisting of an anode active material capable of absorption/desorption of lithium ions which can be made from a variety of materials including silicon, alloys of silicon, and oxides of silicon.

Compositions including nanoparticles and a nano-structured support matrix and methods of preparation as reversible high capacity anodes in energy storage systems, US 2020/10 878 977 B2

The document relates to a composition concerning a lithium-ion battery anode electrode and a preparation method thereof, wherein the electrode consists of nanostructures such as CNTs and in which a vertically aligned nano-structured support matrix is created. An interfacial bond between the nano-structured support matrix and nanoparticles forms an electrode having improved properties for use in lithium-ion batteries. The support matrix may also be grown on a substrate consisting of a current collector material.

Nanotube composite anode materials suitable for lithium-ion battery applications, US 2011/0 104 551 A1

The document relates to an anode material used for lithium-ion batteries which consists of a carbon nanotube composite material. The material consists of aligned carbon nanotubes with a lithium-alloying material on the internal or external surfaces of the tubes. A typical lithium alloying material is silicon. The combination of silicon and aligned carbon nanotubes allows of quicker charge/discharge rates, higher capacities, and greater stability during cycling. This is attributed to the elastic deformability of the CNTs which compensate for large volume expansions and prevent delamination.

Preparation method for negative electrode material of lithium-ion battery, WO 2015/124 049 A1

The document relates to the creation of a negative electrode material for lithium-ion batteries. Carbon nanotubes are dispersed in a solution and put through several processing steps of sintering and drying to form a composite material consisting of CNTs, silicon, and carbon. Silicon is sandwiched between a carbon nanotube network and an outer carbon shell, and serves as a buffer layer to prevent expansion. Further, the conductivity of silicon improves through the CNT network and the outer covering of carbon.

The afore-mentioned documents deal with the usage of CNTs and other carbon additives to enhance electrical, electrochemical and mechanical properties of electrodes. However, there are limitations to the use of CNTs as carbon conductive additives due to their low dispersion within an electrode nanocomposite. Carbon additives have the intrinsic tendency to agglomerate due to the Van der Waal's force, which leads to poor dispersion of them. In order to enhance their dispersion within the mixture, various mixing processes such as ball milling or planetary ball mixing have been used, on top of the chemical and physical modification of carbon nanotubes via functionalization.

The functionalization of CNTs improve the dispersion of CNTs within the composite to improve the overall electrical conductivity, however, the functionalized CNTs have slightly reduced electrical conductivity, compared to the pristine CNTs. Use of surfactants often lets non-conductive surfactant materials remain within the composite after the dispersion. These methods used to disperse CNTs help to improve overall electrical conductivity but may not reach maximum potential electrical conductivity. There are few studies reporting on the de-functionalization of functionalized CNTs in a solution to pristine CNTs.

Thermal treatment of functionalized carbon nanotubes in solution to affect their de-functionalization, WO 2005049488A2

The document relates to the thermal de-functionalization of CNTs in a solution state, making it easily re-suspended. Unlike prior arts where thermal de-functionalize recovers pristine CNTs in a dry state, where they become impossible to re-suspend in a liquid due to a covalent cross-link between multiple CNTs, the presented method involves thermal de-functionalization while it is suspended in a solution form. In the solution, there could be a polymeric material and surfactants mixed. The mixture or blend of materials are thermally treated to de-functionalize CNTs in a suspended form.

However, it is difficult to apply such a method to the manufacturing of an electrode because pristine CNTs in a suspended form is less dispersed in the viscous slurry mixture. Therefore, a method applicable to the manufacturing of an electrode is required where de-functionalization occurs after the dispersion of CNTs and the solidification of the composite material. One potential method is intense pulsed light (IPL) irradiation, a photoelectromagnetic application of energy.

Method of Manufacturing Electrode, Electrode Manufactured according to the Method, Supercapacitor including the Electrode, and Rechargeable Lithium Battery including the Electrode, US 2014/0255776 A1

The document relates to the application of xenon intense pulsed light (IPL) to treat electrodes made of metal oxides, conductive polymers, and carbon materials. In this document, embodiments show that the IPL process applied to relatively less conductive materials such as metal oxides and graphene oxides can reduce them to conductive metals and graphene, making them applicable as electrode materials. This is a fast and simple method of preparing electrodes.

Another method of enhancing an electrode's electrical conductivity involves carbonizing a relatively cheap and less conductive material. There are many prior arts in relation to this process, and some examples are presented herein.

A kind of negative electrode material that soft or hard carbon is compound, preparation method and the capacitor comprising the negative electrode material, CN107993853B

The document relates to the use of soft and hard carbon precursors in the fabrication of an electrode, turning them into a carbon electrode via carbonization processes. Soft carbon precursors include coal tar pitch and asphalt, while hard carbon precursors include sucrose. The embodiments in the document show pre-carbonization and carbonization processes at high temperatures for long durations together with detailed information on temperatures, durations and atmospheric conditions depending on the materials.

Carbon electrode and method of manufacturing thereof, KR101647960B1

The document relates to natural carbon materials and heat-treating thereof to produce carbon-based electrodes. The natural carbon materials include natural fibers, including cotton, hep, flax, jute, sheep, henequen, wool and silk. The carbonization process involves pre-carbonization at 600° C., carbonization at 900-1100° C. and re-carbonization of formed cellulose at 1300-1500° C. to form alkali metal or alkaline earth metal on the surface of carbon electrodes.

### PRIOR ART DOCUMENTS

### Patent Documents

(Document 001) CN 105720265 A (2016.06.29)
(Document 002) U.S. Pat. No. 9,564,629 B2 (2017.02.07)
(Document 003) U.S. Pat. No. 10,878,977 B2 (2020.12.29)
(Document 004) US 2011/0104551 A1 (2011.05.05)
(Document 005) WO 2015/124049 A1 (2015.08.27)
(Document 006) WO 2005/049488 A2 (2005.06.02)
(Document 007) US 2014/0255776 A1 (2014.09.11)
(Document 008) CN 107993853 B (2019.09.17)
(Document 009) KR 10-1647960 B1 (2016.08.08)
(Document 010) US 2010-0035152 A1 (2010.02.11)

### Non-Patent Documents

(Document 001) Li, L., Yang, H., Zhou, D., & Zhou, Y. (2014). Progress in Application of CNTs in Lithium-Ion Batteries. Journal of Nanomaterials, 2014, 1-8. https://doi.org/10.1155/2014/187891.
(Document 002) Tagawa*, K., & Brodd, R. J. (2008). Production Processes for Fabrication of Lithium-Ion Batteries. Lithium-Ion Batteries, 1-14. https://doi.org/10.1007/978-0-387-34445-4_8.
(Document 003) B. J. Landi, M. J. Ganter, C. D. Cress, R. A. DiLeo, and R. P. Raffaelle, “Carbon nanotubes for lithium-ion batteries,” Energy & Environmental Science, vol. 2, no. 6, p. 638, April 2009.
(Document 004) L. Xue, G. Xu, Y. Li, S. Li, K. Fu, Q. Shi, and X. Zhang, “Carbon-Coated Si Nanoparticles Dispersed in Carbon Nanotube Networks As Anode Material for Lithium-Ion Batteries,” ACS Applied Materials &amp; Interfaces, vol. 5, no. 1, pp. 21-25, 2012.
(Document 005) B. J. Landi, M. J. Ganter, C. D. Cress, R. A. DiLeo, and R. P. Raffaelle, “Carbon nanotubes for lithium-ion batteries,” Energy & Environmental Science, vol. 2, no. 6, p. 638, April 2009.
(Document 006) Song, D. P., Li, W., Park, J., Fei, H. F., Naik, A. R., Li, S., Zhou, Y., Gai, Y., & Watkins, J. J. (2021). Millisecond photothermal carbonization for in-situ fabrication of mesoporous graphitic carbon nanocomposite electrode films. Carbon, 174, 439-444. https://doi.org/10.1016/j.carbon.2020.12.036.
(Document 007) Song, D. P., Naik, A., Li, S., Ribbe, A., & Watkins, J. J. (2016). Rapid, Large-Area Synthesis of Hierarchical Nanoporous Silica Hybrid Films on Flexible Substrates. Journal of the American Chemical Society, 138(41), 13473-13476. https://doi.org/10.1021/jacs.6b06947.
(Document 008) Bhandavat, R., & Singh, G. (2013). Stable and Efficient Li-Ion Battery Anodes Prepared from Polymer-Derived Silicon Oxycarbide-Carbon Nanotube Shell/Core Composites. The Journal of Physical Chemistry C, 117(23), 11899-11905. https://doi.org/10.1021/jp310733b.
(Document 009) Colombo, P., Mera, G., Riedel, R., &Soraru, G. D. (2010). Polymer-Derived Ceramics: 40 Years of Research and Innovation in Advanced Ceramics. Journal of the American Ceramic Society, no. https://doi.org/10.1111/j.1551-2916.2010.03876.x.
(Document 010) Arjmand, M. et al., 2011. Electrical and electromagnetic interference shielding properties of flow-induced oriented carbon nanotubes in polycarbonate. Carbon, 49(11), pp. 3430-3440.
(Document 011) Atif, R. & Inam, F., 2016. Reasons and remedies for the agglomeration of multilayered graphene and carbon nanotubes in polymers. Beilstein Journal of Nanotechnology, 7(1), pp. 1174-1196.
(Document 012) Aviles, F. et al., 2009. Evaluation of mild acid oxidation treatments for MWCNT functionalization. Carbon, 47(13), pp. 2970-2975.
(Document 013) Bosze, E. J. et al., 2006. High-temperature strength and storage modulus in unidirectional hybrid composites. Composites Science and Technology, 66(13), pp. 1963-1969.
(Document 014) Breuer, O. & Sundararaj, U., 2004. Big returns from small fibers: A review of polymer/carbon nanotube composites. Polymer Composites, 25(6), pp. 630-645.
(Document 015) Camponeschi, E. et al., 2007. Properties of carbon nanotube-polymer composites aligned in a magnetic field. Carbon, 45(10), pp. 2037-2046.
(Document 016) Chang, C. M. & Liu, Y. L., 2011. Electrical conductivity enhancement of polymer/multiwalled carbon nanotube (MWCNT) composites by thermally-induced de-functionalization of MWCNTs. ACS Applied Materials and Interfaces, 3(7), pp. 2204-2208.
(Document 017) Kim, I. T. et al., 2010. Synthesis, characterization, and alignment of magnetic carbon nanotubes tethered with maghemite nanoparticles. Journal of Physical Chemistry C, 114(15), pp. 6944-6951.
(Document 018) Kim, I. T., Tannenbaum, A. & Tannenbaum, R., 2011. Anisotropic conductivity of magnetic carbon nanotubes embedded in epoxy matrices. Carbon, 49(1), pp. 54-61.
(Document 019) Le, V. T. et al., 2013. Surface modification and functionalization of carbon nanotube with some organic compounds. Advances in Natural Sciences: Nanoscience and Nanotechnology, 4(3), p. 035017.
(Document 020) Lee, J. et al., 2015. Magnetically Aligned Iron Oxide/Gold Nanoparticle-Decorated Carbon Nanotube Hybrid Structure as a Humidity Sensor. ACS applied materials & interfaces, 7(28), pp. 15506-13.
(Document 021) Lee, J., Lee, K. & Park, S. S., 2016. Environmentally friendly preparation of nanoparticle-decorated carbon nanotube or graphene hybrid structures and their potential applications. Journal of Materials Science, 51(6), pp. 2761-2770.
(Document 022) Oliva-Aviles, A. I. et al., 2012. Dynamics of carbon nanotube alignment by electric fields. Nanotechnology, 23(46), p. 465710.
(Document 023) Park, S.-H. & Kim, H.-S., 2015. Environmentally benign and facile reduction of graphene oxide by flash light irradiation. Nanotechnology, 26(20), p. 205601.
(Document 024) Parmar, K. et al., 2013. Effect of CNT alignment on the strain sensing capability of carbon nanotube composites. Smart Materials and Structures, 22(7), p. 75006.
(Document 025) Pramanik, C. et al., 2017. Carbon Nanotube Dispersion in Solvents and Polymer Solutions: Mechanisms, Assembly, and Preferences. ACS Nano, 11(12), pp. 12805-12816.
(Document 026) Sahoo, N. G. et al., 2006. Effect of functionalized carbon nanotubes on molecular interaction and properties of polyurethane composites. Macromolecular Chemistry and Physics, 207(19), pp. 1773-1780.
(Document 027) Li X, Kang F, Shen W., 2006. Multiwalled carbon nanotubes as a conducting additive in a LiNi_{0.7}Co_{0.3}O₂ cathode for rechargeable lithium batteries. Carbon; 44:1334-6.
(Document 028) Sheem K, Lee Y H, Lim H S., 2006. High-density positive electrodes containing carbonnanotubes for use in Li-ion cells. J Power Sources; 158:1425-30.
(Document 029) Wang G, Zhang Q, Yu Z, Qu M., 2008. The effect of different kinds of nano-carbon conductive additives in lithium ion batteries on the resistance and electrochemical behavior of the LiCoO2 composite cathodes. Solid StateIonics, 179:263-8.
(Document 030) Wusiman, K. et al., 2013. Thermal performance of multi-walled carbon nanotubes (MWCNTs) in aqueous suspensions with surfactants SDBS and SDS. International Communications in Heat and Mass Transfer, 41, pp. 28-33.
(Document 031) Xin, F. & Li, L., 2013. Effect of Triton X-100 on MWCNT/PP composites. Journal of Thermoplastic Composite Materials, 26(2), pp. 227-242.
(Document 032) Xin, F. & Li, L., 2012. The role of silane coupling agent in carbon nanotube/polypropylene composites. Journal of Composite Materials, 46(26), pp. 3267-3275.
(Document 033) Yang, Y. et al., 2017. Biomimetic Anisotropic Reinforcement Architectures by Electrically Assisted Nanocomposite 3D Printing. Advanced Materials, 1605750, p. 1605750.
(Document 034) Yim, C. et al., 2017. Eco-friendly and rapid fabrication method of producing polyethylene terephthalate (PET) mask using intensive pulsed light. International Journal of Precision Engineering and Manufacturing-Green Technology, 4(2), pp. 155-159.
(Document 035) Yuen, S.-M. et al., 2006. Preparation, morphology and properties of acid and amine modified multiwalled carbon nanotube/polyimide composite.

### DISCLOSURE

### Technical Problem

The objective of the present disclosure is to provide a method by which a lithium battery electrode with enhanced electrical conductivity is manufactured based on the above-mentioned prior arts.

Specifically, the objective of the present disclosure is to de-functionalize carbon nanotubes after dispersion and drying of electrode nanocomposites and to enhance ionic conductivity by carbonizing polymer binders and removing crystalline structures. Additionally, the electrical conductivity and the anisotropy of the composites are controlled based on alignment and manipulation of directionality of built-in carbon nanotubes or other carbon additives.

Further, the objective of the present disclosure is to provide a lithium battery electrode with enhanced electrical conductivity.

### Technical Solution

The present disclosure relates to an electrode of a lithium battery, in particular, an electrode of a lithium battery, such as a lithium-ion battery, a lithium metal battery, a lithium sulfur battery, and a lithium air battery. The lithium battery includes a current collector, an anode, a cathode, an electrolyte, and a separator.

The present disclosure deals with the use of carbon additives such as carbon nanotubes, carbon nanofibers, graphene, graphene oxides, graphene nanoplatelets etc. to enhance the electrical conductivities of the electrode composite, and dispersion methods to enhance their dispersion within the composite.

Additionally, the present disclosure deals with a photoelectromagnetic energy application process to further enhance the electrical conductivity via de-functionalization of the carbon materials. The photoelectromagnetic energy application process may involve intense pulsed light (IPL) irradiation using a xenon lamp, laser irradiation, microwave irradiation or Joule's heat. In the IPL process, flash of light radiated from the xenon lamp is used. The flash used is light having short-period high power and a wide spectrum. The IPL process is spontaneous, and it is absorbed well by carbon additives which is a main target of the de-functionalization process. In the microwave irradiation process, a high-power microwave spectrum of light is utilized, and high energy is used to excite a molecular vibration using heating.

Carbon additives, including single-walled carbon nanotubes (SWCNTs), multi-walled carbon nanotubes (MWCNTs) such as double-walled carbon nanotubes (DWCNT), carbon nanofibers (CNFs), graphene, graphene oxides, and graphene nanoplatelets (GNPs), are often chemically functionalized with a functional group such as a carboxyl group or an amino group to enhance their dispersion within the mixture, but the existence of the functional group deteriorates the electrical conductivity of an individual carbon additive particle. The photoelectromagnetic application of energy can remove the functional group to further enhance the electrical conductivity of carbon additives.

The applied photoelectromagnetic energy also has several more advantageous effects on the electrode. If carbon additives contain metal impurities, which are the traces of catalysts used in their manufacturing processes, photoelectromagnetic energy application could oxidate them to make them inert to a battery's electrochemical reaction.

The energy could also be utilized to change the material properties of polymer binder materials. The binder materials mechanically hold active materials together and attach them to the current collector. The binder materials can be affected by photoelectromagnetic energy application to change their properties. When high enough energy is applied to the binder materials, the binder materials are carbonized to form a carbon structure surrounding the active materials with enhanced electrical and ionic conductivity. The enhanced electrical and ionic conductivity lead to an increase in the charging and discharging rate of a battery because of the easier diffusion of lithium ions and a decrease in electrical resistance. Additionally, photoelectromagnetic energy application could remove the crystallinity of certain binder materials. Polyvinylidene fluoride (PVDF) is a commonly used polymer binder material for lithium-ion battery electrodes, thanks to its chemical, thermal and mechanical resistance. However, PVDF is well known to have a high crystallinity ratio, regardless of its phase. Photoelectromagnetic energy application can help to remove crystallinity and increase a ratio of PVDF in an amorphous phase rather than a crystalline phase.

Photoelectromagnetic energy application is a simple and cost-effective method to enhance the properties of electrodes in various aspects. Further, another simple method of carbon additive alignment could be utilized in conjunction with photoelectromagnetic energy application process to enhance the material properties of electrodes. The carbon additive alignment process could be performed using various methods such as mechanical shear stress, electrical poling or magnetic poling, all being applicable during a calendaring process by modifying an apparatus. Carbon additives with a high aspect ratio such as CNTs or graphene can create anisotropic material properties depending on the orientation of their alignment. Most importantly, the electrical conductivity can increase in a direction parallel to a direction of their alignment, and then decrease in a direction perpendicular to a direction of their alignment.

The calendaring process, performed in a roll-to-roll (R2R) manufacturing process, could apply mechanical shear stress to align carbon additives in the shear flows of the materials caused by compression, or shear flows caused by vacuum suction. Also, a high enough electrical or magnetic field between the two rollers, alternating current (AC) or direct current (DC) can also induce the alignment of carbon additives. For easier alignment, carbon additives may be chemically or physically functionalized, which would be later de-functionalized via the afore-mentioned photoelectromagnetic energy application processes.

An electric field applied to align carbon additives may also have an additional effect in changing the crystallinity of specific binder materials. Electric poling could induce a phase transition of PVDF from another crystalline phase (alpha or gamma) to a beta phase. While crystallinity of PVDF increases the ionic resistance of the material, the beta phase crystallinity could enhance the hydrophilicity of PVDF, thereby enhancing the diffusion of an electrolyte into an electrode.

The present disclosure suggests materials, methods and apparatus used for the enhancement of electrical conductivity in electrodes and the manipulation of material properties to desired state. With the method to enhance electrical conductivity of the electrode, ratio of conductive carbon additives can be reduced to add more active materials, increasing overall energy density.

Exemplary experiments and their results are also presented to support descriptions in the present disclosure. An IPL application experiment was performed on PVDF-ACNT (acid modified CNT) nanocomposites, and results of FT-IR analysis, EDX analysis and electrical conductivity analysis are presented.

The subject matter of the present disclosure is summarized as follows.

A method of manufacturing a lithium battery electrode according to the present disclosure includes: (a) mixing active materials, carbon additives, and polymer binders and forming a slurry; (b) depositing the slurry on a substrate and forming a coating; (c) drying the coating; and (d) applying energy to the dried coating.

The carbon additives in the step (a) may be chemically functionalized or mixed with surfactants, and the carbon additives may be de-functionalized, or the surfactants may be carbonized, as a result of the application of energy in the step (d).

The polymer binders may be carbonized as a result of the application of energy in (d).

As a result of the application of energy in (d), at least a portion of the polymer binders may be amorphized or a crystalline phase of at least a portion of the polymer binders may change.

As a result of the application of energy in (d), metal impurities included in the dried coating may be oxidized. The application of energy in (d) may be performed in a vacuum atmosphere or an inert gas atmosphere, and oxygen, released from the surfactants or the polymer binders as a result of the application of energy, may be used for the oxidation of metal impurities.

Intense pulsed light (IPL) may be used in (d), for example, and one or more of laser, microwaves, or Joule heating may be used with IPL or without IPL in (d).

The carbon additives may include one or more of carbon nanotubes, graphene, grapheme oxides, carbon nanofibers, and graphite.

The method may further include calendaring using two rollers after (c).

Different electric potentials may be applied to the two rollers.

In the calendaring step, mechanical, electric or magnetic poling may be performed to align carbon additives in a direction parallel with a substrate or perpendicular to a substrate.

The calendaring step may include one or more of the following steps:
a. thermally annealing semi-crystalline polymer binders and inducing a beta-phase transition,
b. electrically poling semi-crystalline polymer binders and inducing a beta-phase transition,
c. aligning carbon additives to be in parallel with an electrode plane by using heat and compression,
d. aligning carbon additives to be perpendicular to an electrode plane by applying vacuum pressure, and
a. aligning carbon additives to be perpendicular to an electrode plane by using an electric field or a magnetic field applied between the two rollers.

### DESCRIPTION OF DRAWINGS

Referring to the drawings, several aspects of the present invention are illustrated by way of examples, not by way of limitations, in detail in the figures, wherein:

FIG. 1 shows functionalization and de-functionalization processes of CNTs, in which functionalized CNTs has a carboxyl group, a hydroxyl group or an amine group attached to their carbon wall through the acid and urea treatment-based functionalization process, and reverts them back to their pristine state through the de-functionalization process as a result of the application of energy such as IPL, microwaves, and Joule heating and the like;

FIG. 2 shows a change in the crystalline structure of PVDF from an alpha phase to a beta phase through electric polling and annealing. Beta-phase PVDF has increased surface hydrophilicity, leading to improvement in the diffusion of electrolytes;

FIG. 3 shows a modified R2R process in which an electric field is used to align carbon additives and to change the crystalline phase of PVDF;

FIG. 4 illustrates a method of manufacturing an electrode, including the slurry mixing and ultrasonication of a mixture including functionalized CNTs, blade coating on a current collector, drying, R2R calendaring and de-functionalization, and the de-functionalization of the CNTs occurs in a final IPL process, thereby improving material properties;

FIG. 5 is showing solvent-suspended MWCNTs, where (a) is a pristine MWCNT sample, (b) is an acid modified MWCNT sample and (c) is an IPL-treated MWCNT sample. The MWCNT samples were stirred and sonicated under the same conditions, but (b) the acid modified MWCNT sample stayed dispersed for the longest time while (a) the pristine MWCNT sample and (c) the IPL-treated MWCNT sample sank to the bottom and agglomerated faster;

FIG. 6 is SEM image of active materials encapsulated with polymer binders and carbon additives after IPL application. 89.1 wt. % of NMC 811 as an active material, 10 wt. % of PVDF as a polymer binder, and 0.9 wt. % of acid modified MWCNTs were included. IPL was applied in a container filled with nitrogen for 6 ms at power of 2900 V;

FIGS. 7a, 7b and 7c show results of (a) 1500-500 cm⁻¹ FT-IR, (b) 3500-1500 cm⁻¹ FT-IR and (c) EDX of a PVDF-ACNT film in relation to varying power of irradiated IPL;

FIGS. 8a and 8b show (a) sheet resistance and (b) electrical conductivity, in relation to varying power of irradiated IPL;

FIGS. 9a and 9b show results of comparison of the electrical capacitance of half cells before and after IPL application; and

FIG. 10 shows results of electrochemical impedance spectroscopy on electrodes before and after IPL application.

### MODE FOR INVENTION

The following description and the embodiments set forth herein are provided to describe the principles of the subject matter of this disclosure. These embodiments are provided for the purposes of description of, not of limitation to, those principles and of the subject matter in various aspects. Throughout the disclosure and drawings, identical reference numerals are given to similar parts. The drawings are not necessarily based on a scale, and in some instances, proportions can increase in order to depict certain features more clearly.

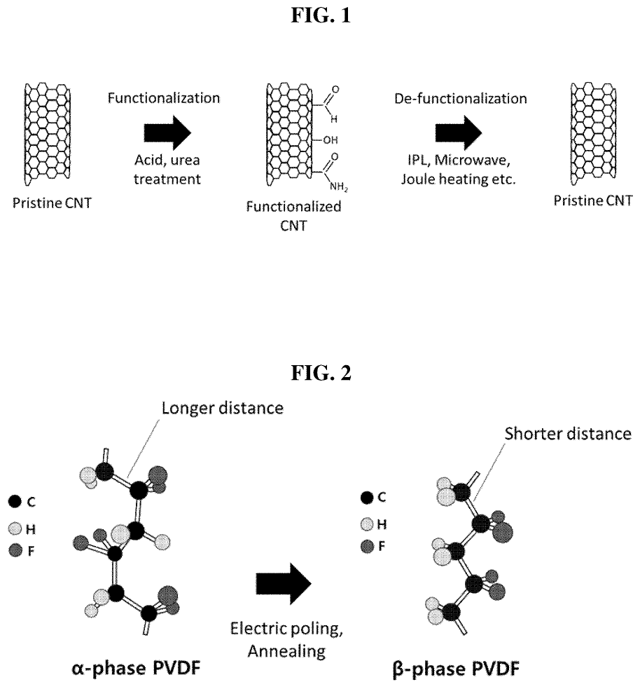

FIG. 1 shows functionalization and de-functionalization processes of CNTs, in which functionalized CNTs have a carboxyl group, a hydroxyl group or an amine group attached to their carbon wall through the acid and urea treatment-based functionalization process. Functionalized CNTS are reverted back to their pristine state through the de-functionalization process as a result of the application of energy such as IPL, microwaves, and Joule heating and the like.

Effects of Addition of Carbon Additives

Understanding the material properties of nanocomposite materials starts with understanding a matrix and filler materials. In most cases, filler materials are added to enhance certain properties that a matrix is deprived of. Polymeric CNT nanocomposites are desirable because CNTs have high electrical conductivity, thermal conductivity, and tensile strength which most of the polymer matrices lack [Breuer & Sundararaj 2004].

The properties of CNTs soon attracted the attention of the lithium-ion battery industry. They were first applied to cathode composite materials, such as a layer-structured compound of LiCoO₂. Carbon black (CB) and carbon fibers (CF) were used first, but soon it was found that multi-walled CNTs (MWCNTs) could increase the capacity, the charge-discharge rate and the lifespan of lithium-ion batteries [Wang et al. 2008]. Experiments showed that cathodes with MWCNTs outperformed those with conventional conducting agents such as carbon black [Kang and Shen 2006, Sheem et al. 2006]. It was found that MWCNTs exhibit better electrical conductivity and that the high aspect ratio of MWCNTs also help to maintain a conductive network through repeated cycles of charging and discharging processes and mechanically hold nanocomposite electrodes. Its effectiveness is shown in most kinds of composite cathodes, especially compared to less effective carbon fibers and carbon blacks.

CNTs were also considered a good conductive additive for anodes. With their unique capacity to intercalate lithium ions, CNTs were also considered as a replacement for active materials such as graphite but were put at a disadvantage in terms of production costs compared to commercial graphite. CNTs, a conductive additive in anodes materials, attracted more attention with the rise of largely-volume-changing, metal-alloying active materials, such as silicon, tin, bismuth, and titanium oxides. These materials are known for high energy density compared to conventional graphite anodes, but they experience a large volume change and subsequent pulverization, delamination, and undesirable formation of solid electrolyte interphase (SEI). CNTs, along with their high electrical conductivity, could utilize their conductive network to suppress the volume change of active materials, and mitigate resulting loss of electrochemical performance by holding the active materials and binder materials together.

Dispersion of Carbon Additives

CNTs and carbon additive nanoparticles all have the tendency to agglomerate together. The agglomeration occurs because of the Van-der-Waals forces of CNTs attracting each other. It has been a persistent problem in the production of polymeric CNT nanocomposites and any other composites with carbon-based nanofillers [Atif &Inam 2016].

In order to achieve homogeneous material properties (in a macroscopic scale), research has been performed into uniform dispersion of nanofillers. The dispersion of nanofillers is directly related to a solvent in which nanofillers are dispersed. Although it is found out that all systems of CNTs and solvents prefer an agglomeration state since dispersion is energetically less favorable [Pramanik et al. 2017], some solvents require less energy to disperse CNTs and also maintain the dispersed state longer.

In general, CNTs are dispersed better in a non-polar solvent in comparison to a polar solvent such as water because of the hydrophobic nature of pristine CNTs [Wusiman et al. 2013]. Molecular geometry of a solvent also affects the dispersion as more pyramid shaped DMSO interact less effectively with CNTs in comparison to DMF (dimethyl formamide) and DMC (dimethyl carbonate) that are planar and oriented in parallel with the surface of CNTs. The molecular geometry and polarity of a used polymer matrix also affect the dispersion of CNTs[Pramanik et al. 2017].

The choice of a solvent and a polymer is often made prior to designing the dispersion of CNTs since the type of a polymer matrix usually determines resulting material properties. Thus, an additional technique is required to lower required dispersion energy or to provide energy. Mechanical dispersion methods such as ultrasonication (high-frequency vibrations to agitate particles in a solution), calendaring (shear force in roll milling of a viscous mixture) [Gojny et al. 2004] and ball milling (grinding of bundled fillers) [Li et al. 1999] are often used to disperse nanofillers by providing energy required to disperse CNTs.

The dispersion of CNTs was compared with respect to sonication time. CNTs were dispersed in an aqueous solution of distilled water and SDS (sodium dodecyl sulfate) at a ratio of 1:300 right before measurement. Since the overlap of the bands of surfactants and CNTs were possible in UV-vis measurement, the spectra of the surfactant solution were measured and a baseline was corrected. An increase in the sonication time led to an increase in the absorbance, indicating better dispersion of CNTs in the solution[Sobolkina et al. 2012].

Mechanical dispersion methods are readily applied and not limited in the applicable type of polymer or solvent. However, mechanical dispersion methods are often not enough by themselves to fully disperse CNTs or other nanofillers since they could damage the surface and shorten the length of nanofillers [Lu et al. 1996] when excessive energy is transferred. In many cases, damage occurs before CNTs are fully dispersed. Therefore, mechanical dispersion methods are often utilized together with other techniques while limiting the time and intensity where nanofillers are exposed.

There is another process called functionalization, in which other molecules are attached to the surface of CNTs to provide different properties to the CNTs. Depending on the type of functionalization, the electrical properties of CNTs can be enhanced, magnetic properties are provided, a link between CNTs and surrounding polymers can be created, or simply, CNTs can be better dispersed. There are two types of functionalization. One is physical functionalization, and the other is chemical functionalization. Hirsch categorized chemical functionalization into defect-group functionalization and covalent sidewall functionalization and categorized physical functionalization into exohedral and endohedral functionalization.

Physical Functionalization (Use of Surfactant)

Physical functionalization is a non-covalent bond between CNTs and molecules, usually maintained by pi-stacking (π-π interactions) or physical adsorption of the molecules on the surfaces of the CNTs. Since this happens on the outer shells of the CNTs, it's called exohedral functionalization. There's another type of physical functionalization called endohedral functionalization where atoms or molecules are inserted inside the CNTs, but the endohedral functionalization method has negligible effects on the dispersion of CNTs [Georgakilas et al. 2007].

Surfactants are a common example of physical functionalization for the dispersion of nanofillers. The defect-group functionalization or covalent side-wall functionalization techniques cause damage to an original carbon chain of nanofillers, thereby altering the nanofillers' mechanical and electrical properties. Surfactants have a non-covalent bond with nanofillers, maintaining their original properties while altering surface energy.

The effects of various surfactants on the dispersion of CNTs were investigated based on UV-vis spectra of solutions with different surfactants. The value of absorbance at a specific wavelength is proportional to an amount of de-bundled CNTs [Grossiord et al. 2005], and thus, it is possible to ascertain how well CNTs are dispersed using UV-vis spectra. Study of Inam et al. showed that GA (gum arabic) has a better dispersion effect than SDS (sodium dodecyl sulphate)but exhibit maximum dispersion when both surfactants were used together [Inam et al. 2014]. Anon-ionic surfactant called Triton™ X-100 (polyoxyethylene octyl phenyl ether) or Tween-20™ and how it improved the material properties of MWCNT-polypropylene (MWCNT-PP) nanocomposites through dispersion were investigated. It was found out that Triton™ X-100 enhanced the dispersion of CNTs in the MWCNT-PP nanocomposites. The improved dispersion of the CNTs also increased the electrical conductivity and the tensile modulus of the MWCNT-PP nanocomposites. Similar results were also observed in an investigation using a silane coupling agent (ZFDA, Dow Corning Z-6173) as s surfactant [Xin & Li 2012].

Disadvantages of Surfactants

However, the use of surfactants was not always the best method of disperse CNTs. A report revealed that the addition of an excessive amount of surfactants actually decreased the electrical conductivity of CNTs [Xin and Li 2012]. This does not mean that the dispersion effect decreased, it means that an increase in the volume of non-conductive surfactants countered an increase in the electrical conductivity caused by a better dispersion of CNTs. Such phenomena were also shown in relation to SDS and SDBS (sodium dodecylbenzensulfonate), where the thermal conductivity of nanocomposites with surfactants was lower than that of nanocomposites without surfactants [Wusiman et al. 2013].

Chemical Functionalization

Another type of functionalization called covalent functionalization or defect group functionalization involves adding different atoms or molecules to CNTs. It is widely accepted that such chemical functionalization disrupts extended π-conjugation of nanotubes, thereby reducing the electrical conductivity of isolated nanotubes while the impact on mechanical and thermal properties is limited. However, there are numerous reports that improved dispersion enabled by chemical functionalization far outweighs disadvantages in relation to the electric conductivity of CNTs [Moniruzzaman& Winey 2006].

There are two primary methodologies of covalent chemical bonds depending on the building of molecular chains. A ‘grafting to’ methodology involves a synthesis of a polymer with a specific molecular weight terminated with reactive groups or radical precursors. In subsequent reactions, a polymer chain is attached to the surface of nanotubes by an addition reaction. A ‘grafting from’ methodology involves growing polymers from the surface of CNTs via in-situ polymerization of monomers initiated by chemical species immobilized on the sidewalls and edges of the CNTs[Spitalsky et al. 2010].

In the disclosure, the ‘grafting to’ method is introduced mainly because it can utilize pre-formed commercial polymers of controlled molecular weight and polydispersity, which fulfills the purpose of dispersing CNTs via functionalization. This functionalization method usually begins with the functionalization of carboxylic acid of CNTs, often called ‘acid treatment’ of CNTs.

Acid treatment of CNTs can be performed with various types of acids in different process parameters. Some conventional methods involve mixing sulfuric acid and nitric acid at a ratio of 3:1 [Gao et al. 2005; Sahoo et al. 2006; Meng et al. 2008], and others at a ratio of 3:2 [Yuen et al. 2006]. Time taken by CNTs to be stirred in an acid solution also varies, and a general rule of thumb is applied where CNTs are stirred for a longer period of time if a stirring temperature is lower. The CNTs reacted in the acid solution are then washed with a large amount of DI water, filtered and dried, to remove any excess of acid such that only functionalized CNTs are left.

Samples not treated with acid or treated with a very mild acid show the sedimentation of agglomerated CNTs while other samples treated with acid show dispersed CNTs are suspended in the solution even after 24 hours. Carboxylic acid functionalized CNTs through the acid treatment have better dispersion in polymer nanocomposites, improving their mechanical properties. While an amine group is slightly less polar than the carboxylic acid group, reports show that amine and diamine functionalized CNTs have more homogeneous dispersion within a certain polymer matrix (i.e., polyamide) than the carboxylic acid functionalized CNTs. Acid modified and amino-modified MWCNTs are both dispersed better than pristine MWCNTs within polyamide, while Young's modulus of PA-MWCNT nanocomposites was largest when amino-modified MWCNTs were used at a low concentration.

Alignment of CNTs

Enhancement in the dispersion of nanofillers led not only to improvement in the mechanical, electrical and thermal properties of the nanocomposites, but to homogeneous material properties in the bulk volume of the nanocomposites. Studies have further found out that nanofillers with a high aspect ratio such as CNTs could be aligned in a specific direction within the nanocomposites to have anisotropic material properties. The anisotropic material properties could be utilized in various applications. One example is directional conductivity, where a material is electrically conductive in a vertical direction but not in a lateral direction. This could be a desirable property in conventional lithium-ion batteries where batteries are produced in a layer-by-layer structure.

There are three primary methods to align CNTs that are carbon additives. The first method is mechanical alignment where flow-induced shear stress is used to align CNTs. The second method is magnetic alignment of CNTs using a magnetic field, and the last is electric alignment of CNTs using an electric field.

The mechanical alignment method is used when melt mixing is used to fabricate polymeric CNT nanocomposites. Unlike the magnetic or electrical alignment methods where alignment occurs in a low viscosity solution state, the mechanical alignment method utilizes the flow of viscous polymers themselves to create shear stress aligning fibers. Injection molding or compression molding of polymeric CNT nanocomposites are good examples of this.

Polycarbonate-MWNCT (PC-MWCNT) compression molding of disks and micro-injection molding of dog-bone shaped samples with different shear rates were investigated. It was found out that the compression molding of the disks results in radial alignment of CNTs while the micro-injection molding of the dog-bone shaped samples results in linear alignment of CNTs. It was also found that the higher shear rate, the higher degree of alignment of CNTs [Abbasi et al. 2010]. Also, a report indicates that the injection molding of PC-MWCNT could align CNTs and induce anisotropic electrical conductivity [Mahmoodi et al. 2012; Parmar et al. 2013; Arjmand et al. 2011] and thermal conductivity [Mahmoodi et al. 2015] in nanocomposites.

A disadvantage in this technique is that the shear stress/strain, if difficult to control, and a degree of the alignment are greater near the surface, where higher shear stress is experienced. This results in inhomogeneous material properties across the volume of the nanocomposites.

The magnetic and electric alignment methods give more homogeneous nanocomposite samples compared to the mechanical alignment method. The magnetic and electrical alignment methods require nanofillers to be magnetic or electric while the injection molding method of aligning nanofillers is applicable to any nanofillers.

While it is possible to align pristine CNTs with a magnetic field [Camponeschi et al. 2007], low magnetic susceptibility of CNTs requires a relatively high magnetic field (15 T or higher). Researchers have found out that CNTs could be decorated with more magnetic susceptible nanoparticles such as iron oxide. Maghemite (γ-Fe₂O₃) MWCNT hybrids were synthesized, which were mixed with an epoxy resin and exposed to the magnetic field of 0.3 T. They created magnetic CNTs which were strongly oriented and aligned in the direction of the magnetic field [Kim et al. 2010; Kim et al. 2011].

The electrical alignment method is easy to process and highly efficient in the alignment of CNTs, compared to the mechanical and magnetic alignment methods [Yang et al. 2017]. It utilizes dielectrophoresis, a phenomenon in which a force is exerted on dielectric particles (i.e., CNTs) to move them toward the position of a maximum electric field strength. Additionally, manufactured was a 3D printing machine capable of aligning CNTs in any desired direction in each layer of a printed material using a DC electric field [Yang et al. 2017]. However, the DC electric field alignment method has a problem similar to that of the magnetic field alignment method. If the field is strong enough, there is a high probability that CNTs not only align themselves along the electric (or magnetic) field, but they also migrate because of the directionality of the field [Lee et al. 2016].

An AC electric field alignment method was developed to solve the problem with the DC electric field alignment method. The alternating direction of an electric field prevents CNTs from moving while the CNTs are aligned with dielectrophoretic-induced torque. Pristine MWCNTs were mixed in a PSF (polysulfone) matrix, and then an electric field of 13.3 kVp/pm was applied at a frequency of 1 kHz. There is a big difference between electrical resistance measured in a direction parallel and perpendicular to the electric field especially at low CNT concentrations [Oliva-Aviles et al. 2012].

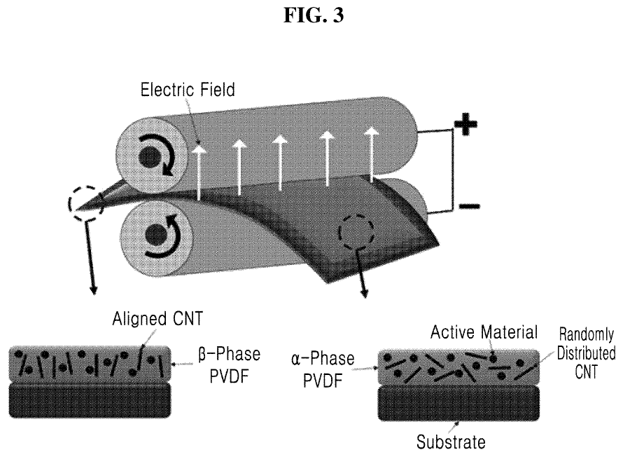

In the disclosure, described is a new electrode manufacturing process inducing alignment of CNTs or other conductive carbon additives in a desired orientation for manipulation of electrical and mechanical properties. To align conductive carbon additives within electrodes, a slurry mixture of electrodes is deposited on a current collector. As the electrode is put through between two rollers, the rollers can induce alignment of CNTs and the like in various ways (see FIG. 3), including mechanical shear stress, vacuum suction, an electric field, or a magnetic field.

FIG. 2 shows a change in the crystalline structure of PVDF from an alpha phase to a beta phase through electric polling and annealing. Beta-phase PVDF has increased surface hydrophilicity, leading to improvement in the diffusion of electrolytes.

FIG. 3 shows a modified R2R process in which an electric field is used to align carbon additives and to change the crystalline phase of PVDF.

Mechanical shear stress can be applied by compression from two rollers. Compressive forces would induce a shear flow to the slurry material as the material is flattened, applying the required shear stress to induce the alignment. This method would induce alignment of carbon additives in parallel to the electrode's plane. In order to induce alignment of carbon additives perpendicular to the electrode's plane, an electric field or a magnetic field could be applied to the electrode.

To apply the electric field, the rollers can be used as conductive pols to apply electrical potentials. A voltage difference may be applied in direct current (DC) or alternating current (AC). Because of the alignment of the carbon additives dependent on the viscosity of the material, strength of the electric field and an expose duration, a feed speed of the roll-to-roll process may be decreased or repeated multiple times to achieve a desired degree of alignment.

The rollers of a roll-to-roll feed system may be permanent magnets or electromagnets to generate a magnetic field. While it requires a high-strength magnetic field to align pristine CNTs or carbon additives, they can be physical functionalized with iron oxide nanoparticles to induce the alignment more easily as described earlier.

In an exemplary experiment, alternating current was utilized to align CNTs within polymeric nanocomposites. The nanocomposite sample was prepared using solution casting techniques. PVDF matrix was prepared by mixing PVDF and dimethyl formamide (DMF) at a ratio of 1:10. The mixture was stirred for 24 hours on a hot plate at 80° C. to dissolve PVDF in DMF completely. 10 wt. % of carboxyl functionalized MWCNTs were added into a solution, mixed and dispersed through ultrasonication for 30 minutes.

The mixture was poured into the cast where an electric field generator was set up. A high-voltage piezoelectric amplifier (PI E-463) was utilized in conjunction with a function generator, applying a sinusoidal wave of 230 Vₚ₋ₚ at 250 Hz over a 3 cm gap between two copper electrodes. An AC electric field of 7.68 kVₚ₋ₚ/m was generated between the two electrodes. After 12 hours of application of an electric field, the sample was irradiated with IPL for rapid polymerization and CNT de-functionalization.

The sample acquired from the AC electric field CNT alignment process was then analyzed using a 4-point probe resistance meter. Measurements of the square-shaped samples were performed across a width and across a length, one parallel to the applied electric filed and other perpendicular to the applied electric field.

TABLE 1
Resistance measured for samples with and without CNT alignment

| Samples | Resistance (kΩ) | R_{W}/R_{L} |
|---|---|---|
| Pure PVDF | 53.3 ± 1.25 | 1 |
| PVDF-MWCNT, no alignment, | 3.72 ± 0.20 | 1.03 |
| measured in width direction | | |
| PVDF-MWCNT, no alignment, | 3.69 ± 0.20 | |
| measured in length direction | | |
| PVDF-MWCNT, electric alignment, | 30.1 ± 2.20 | 7.48 |
| measured in width direction | | |
| PVDF-MWCNT, electric alignment, | 5.36 ± 1.15 | |
| measured in length direction | | |

The randomly oriented nanocomposites without electric alignment showed resistance almost constant regardless of the measurement direction as expected. In the case of nanocomposites with aligned CNTs to which an AC electric field was applied, the measurement in a direction perpendicular to a direction of the alignment of the CNTs showed resistance significantly larger than the measurement in a direction parallel with a direction of the alignment of the CNTs. Clear anisotropic electrical resistance was observed where a ratio of resistance in the width direction to resistance in the length direction was found to be 7.48. From the resistance values highly dependent on the measurement orientation, it could be concluded that the CNTs were well aligned.

Fabrication and Characterization of Experimental Electrodes

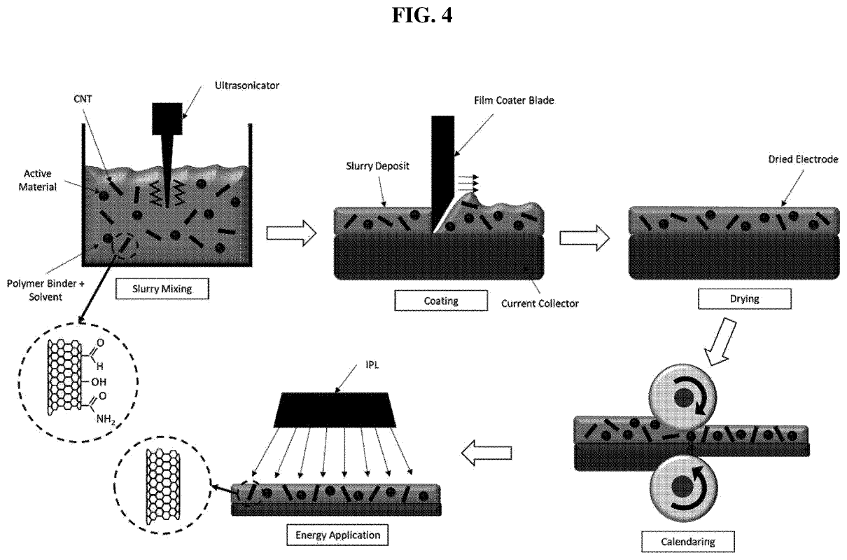

A sample electrode was fabricated to verify the effects of application of photoelectromagnetic energy through IPL. First, an experimental PVDF-ACNT (acid modified MWCNTs) nanocomposite film was created. PVDF-ACNT with 6 wt. % of CNTs was mixed using ball milling at 300 RPM for 3 hours and agitated using an ultrasonic sonicator for 2 minutes. The slurry mixture was then coated on aluminum foil and dried using a vacuum oven for 1 hour. Then IPL was applied to the sample at different levels of power from 2.2 kV to 2.8 kV at a 20 mm distance. The sample electrode manufacturing process is presented in the schematic view of FIG. 4. As illustrated in FIG. 4, the electrode manufacturing process could include slurry mixing of a mixture including functionalized CNTs, ultrasonication, blade coating on a current collector, drying, R2R calendaring and de-functionalization. The resulting samples were analyzed using FT-IR, EDX and resistance measurement.

De-Functionalization

An advantage of the chemical functionalization of CNTs using acid is that it produces a strong dispersion effect. A potential drawback of the chemical functionalization of CNTs is that it is a more complicated process and creates damage to the surface of CNTs, which decreases the electrical conductivity of each individual CNT.

In the disclosure, the potential drawback due to the reduced electrical conductivity was addressed by introducing a technique called in-situ de-functionalization through irradiation of intense pulsed light (IPL). The de-functionalization process of functionalized CNTs could vary depending on the type of a functional group attached to the CNTs. For acid modified CNTs, a chemical reduction or a simple application of energy in the form of heat in a reducing environment could revert the functionalized CNTs back into their pristine state. However, once the functionalized CNTs are de-functionalized, then they lose the ability to disperse evenly within polymer nanocomposites.

In order to utilize the dispersion effect of functionalized CNTs and maintain the conductivity of pristine CNTs at the same time, thermal treatment of solidified polymeric CNT nanocomposites was suggested. PVDF-MWCNT nanocomposites were prepared where MWCNTs were functionalized with large molecules such as N-(4-Hydroxyphenyl)maleimide (NHMI) via Diels-Alder reaction to achieve homogeneous dispersion of MWCNTs within PVDF matrix. Once the MWCNT-PVDF was solidified, they induced retro-Diels-Alder reaction by applying heat at 160° C. for 3 hours. As a result, electrical conductivity improved after the heat treatment [Chang & Liu 2011].

In the disclosure, intense pulsed light (IPL) was used to supply required energy instead of heating the nanocomposites for a long time, thereby greatly enhancing production efficiency. A successful reduction of graphene oxide into reduced graphene oxide by the irradiation of IPL was already disclosed in other papers [Yim et al. 2017; Park & Kim 2015].

In the disclosure, the application of IPL for de-functionalization of acid modified MWCNTs has been performed, especially in a polymer solution. This was the application of IPL for rapid de-functionalization of acid modified CNTs, which maintains the position of dispersed CNTs while regaining higher electrical conductivity of pristine CNTs.

In the experiment, the acid modified MWCNTs were prepared using formic acid treatment. Pristine MWCNTs (Industrial grade; 10-30 nm diameter and 10-30 μm length) of 1 g were mixed with 250 mL of reagent-grade formic acid. The mixture was ultrasonicated for 10 minutes in are action vessel and stirred at 90° C. for 100 minutes to functionalize CNTs. The mixture was cooled down to room temperature while stirring, then diluted with 750 mL of DI water before filtration. The mixture of the diluted formic acid and functionalized MWCNTs were filtrated using a vacuum funnel, and the filtered MWCNTs were washed with DI water until its pH level reached 7. The filtered MWCNTs were washed again with acetone to remove any excess of water or remaining acid, and then dried with vacuum for 24 hours. The dried MWCNTs were then collected, giving approximately 80% yield.

A simple colloidal test was performed to see the effect of IPL on CNT de-functionalization and its dispersion effectiveness. Half of the acid-treated MWCNTs prepared above was exposed to xenon-flash IPL at 3600 W for 6 ms. The samples of pristine MWCNTs, acid modified MWCNTs, acid modified and IPL-exposed MWCNTs were suspended in deionized water and sonicated for 30 minutes. The pictures of colloidal samples were taken an hour after the sonication.

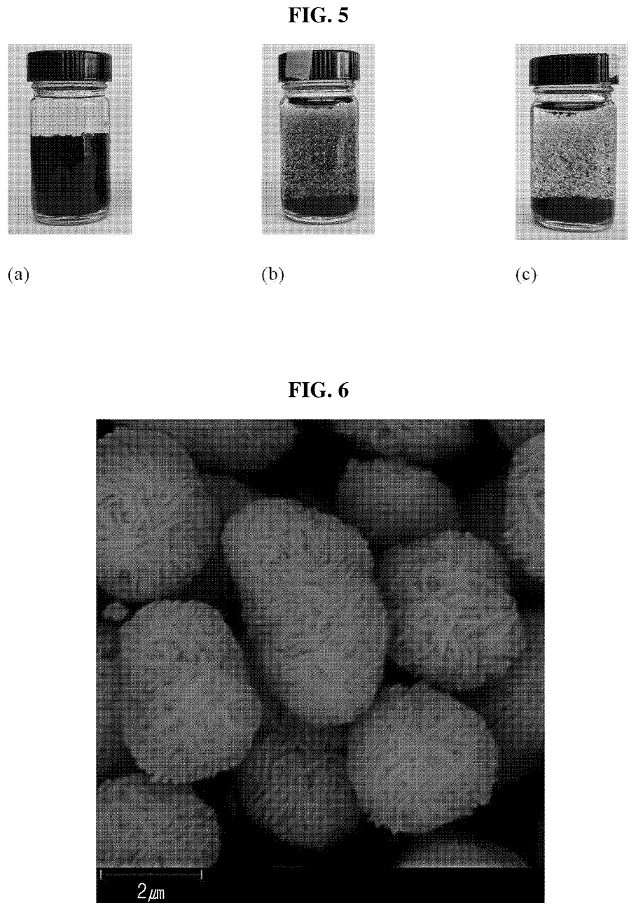

FIG. 5 is views showing solvent-suspended MWCNTs, where (a) is a pristine MWCNT sample, (b) is an acid modified MWCNT sample and (c) is an acid-modified and IPL-treated MWCNT sample.

As observed in the colloid test of FIG. 5, (a) the pristine MWCNT sample sank at the bottom of a container, (b) the acid modified MWCNT sample remained dispersed and suspended, and (c) the acid modified then IPL-exposed MWCNT sample sank more than the acid modified MWCNT sample although (c) the acid modified and IPL-exposed MWCNT sample sank less than a) the pristine MWCNT sample.

This indicates that functionalized CNTs after functionalization with acid revert to their pristine CNTs to a certain degree after exposure to IPL.

For a better understanding, MWCNT-PDMS nanocomposite samples were fabricated using the carboxylic acid functionalized MWCNTs to identify the effects of functionalization and de-functionalization. For 2.5 g of PDMS, 0.25 g of a curing agent and 0.25 g of acid modified MWCNTs were mixed in 6 g of chloroform. The sample was stirred for 2 hours at room temperature and sonicated for 30 minutes in an ultrasonication bath.

The sample was divided equally into three petri dishes. Two of them were heated at 45° C. for 8 hours for complete evaporation of the solvent and polymerization to occur. The other sample was irradiated with Xenon-flash IPL at 3600 W for 6 ms. An additional petri dish of MWCNT-PDMS was prepared with a reference sample using pristine MWCNTs. The resulting MWCNT samples were compared by measuring electrical resistance on the top and bottom surfaces at two points separated by 2 cm. Measurement was taken five times for each sample, and average resistance of each sample was measured and listed in Table 2.

TABLE 2
Resistance of PDMS-MWCNT samples before
and after de-functionalization

| PDMS-MWCNT Sample | 2-probe resistance (kΩ) |
|---|---|
| Pristine MWCNT | 30.2 ± 0.22 |
| Acid treated MWCNT | 5.44 ± 0.59 |
| Acid treated MWCNT, irradiated | 0.960 ± 0.50 |
| before polymerization | |
| Acid treated MWCNT, irradiated | 318 ± 85.5 |
| after polymerization | |

As expected, a sample with acid modified MWCNTs showed decreased electrical resistance because of enhanced dispersion, compared to a sample with pristine MWCNTs. Interestingly, the irradiation of IPL affected the samples differently depending on the timing of the irradiation. When the irradiation occurred before the sample was solidified/polymerized, the resulting resistance of the sample was lowest, meaning electrical conductivity improved because of de-functionalization. The irradiation after the polymerization led to a drastic increase in electrical resistance, compared to the sample with pristine MWCNTs. Based on observation during the irradiation of IPL, a hypothesis was set up that excessive energy from IPL irradiation was absorbed during the evaporation of a solvent and a rapid polymerization process when the IPL irradiation was applied before solidification/polymerization, while excessive energy was used to burn and damage MWCNT-PDMS nanocomposite samples when the IPL irradiation was applied after the solidification.

FIG. 6 is SEM image of active materials encapsulated with polymer binder and carbon additive after IPL application.

89.1 wt. % of NMC 811 as an active material, 10 wt. % of PVDF as a polymer binder, and 0.9 wt. % of acid modified MWCNTs were included. IPL was applied in a container filled with nitrogen for 6 ms at power of 2900 V.

Referring to FIG. 6, the polymer binders formed a network of a thin neural network shape attached to NMC active materials after IPL application. Such a form helps to increase a contact surface area and electrical conductivity and improves lithium ion diffusion.

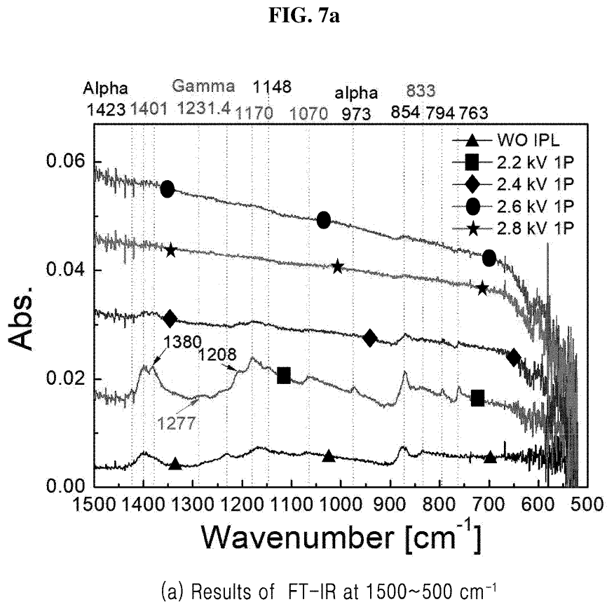

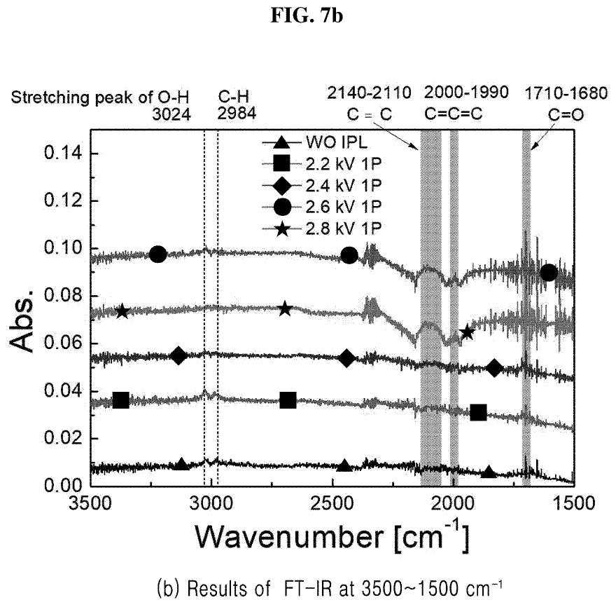

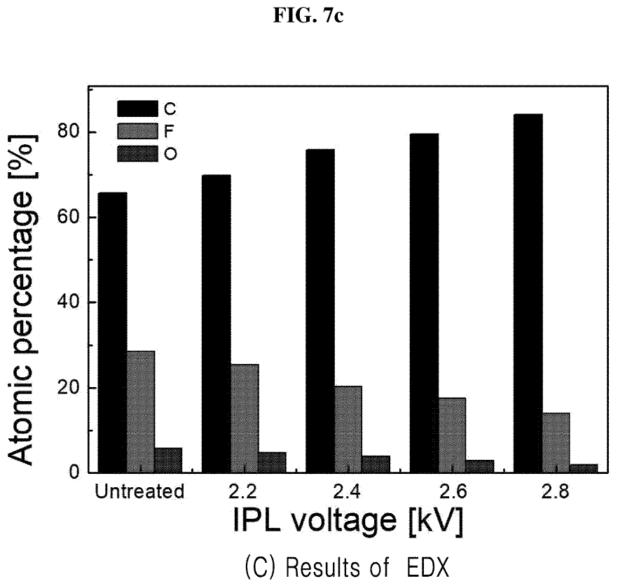

FIGS. 7a, 7b and 7c show results of (a) 1500-500 cm⁻¹ FT-IR, (b) 3500-1500 cm⁻¹ FT-IR and (c) EDX of a PVDF-ACNT film, based on applied power of IPL. The PVDF-ACNT film was comprised of PVDF and 1 wt. % of acid modified MWCNTs. IPL was applied at different levels of power, from 2.2 kV to 2.8 kV, for 6 ms, at a 2 cm distance between an IPL lamp and the film.

In an IPL-untreated ACNT/PVDF film, the α phase of PVDF was observed at 763, 854, 1148, and 1423 cm⁻¹, the β phase of it was observed at 1070 and 1170 cm⁻¹, and the γ phase of it was observed at 833, 1231, and 1401 cm⁻¹. Upon IPL treatment at 2.2 kV, the crystallinity of PVDF improved as the α phase at 794, 973, 1208, and 1380 cm⁻¹, and the β phases corresponding to 1277 cm⁻¹ was additionally formed. However, as a value of the IPL voltage increased from 2.4 to 2.8 kV, peak intensity corresponding to the α, β, and γ phases gradually decreased, and the α phase at 854 cm⁻¹ was only observed in the IPL treatment at 2.8 kV. Based on these results, it could be concluded that IPL application reduced the crystallinity of PVDF corresponding to u, R, and γ phases, and carbonized PVDF. A decrease in the crystallinity of PVDF can improve ionic conductivity.

Compared to a decrease in the crystallinity of PVDF with an increase in the IPL voltage, the carbonization of PVDF improved as shown in FIG. 7b. In the case of non-treatment of IPL, peaks corresponding to C═C═C between 1900 and 2000 cm⁻¹ and C≡C between 2140 and 2100 cm⁻¹ were not present. However, as the IPL voltage increased from 2.2 to 2.8 kV, the intensity of these peaks gradually increased. Similar to the FT-IR results, the proportion of fluorine in the EDX results decreased with an increase in the IPL voltage in FIG. 7c. Before the IPL treatment, the atomic percentage was 65.75, 28.6, and 5.65% of C, F, and O, respectively. As the IPL voltage increased from 2.2 to 2.8 kV, the atomic percentage of C increased from 65.75 to 84.08%, whereas that of F and O decreased from 28.6 to 13.98% and from 5.65 to 1.91%, respectively. As a result, the ionic conductivity of PVDF was enhanced by reducing the crystallinity of PVDF (i.e. alpha and gamma phase peaks decreased), and the mechanical and chemical stability of it was secured by carbonization at the same time.

As shown in FIG. 7b, IPL application results in de-functionalization of acid modified carbon nanotubes. Before the IPL treatment, peaks corresponding to C═O between 1710 cm⁻¹ to 1680 cm⁻¹ were present, and —COOH groups were present in the acid modified carbon nanotubes. During the IPL treatment at 2.2 kV and 2.4 kV, the peaks remained. However, at IPL voltage of 2.6 kV or greater, the peaks were completely removed. Additionally, an increase in the IPL voltage led to removal of peaks corresponding to O—H and C—H between 3024 cm⁻¹ and 2984 cm⁻¹, and during the IPL treatment, the two peaks were all removed at 2.8 kV.

As a result, the FT-IR analyses of FIGS. 7a and 7b shows that as IPL power increases, peaks of the alpha and gamma-phase crystalline structure of PVDF decrease and peaks corresponding to 0-H decreases, resulting in more de-functionalization of acid modified carbon nanotubes, and the EDX analysis of FIG. 7c shows that as IPL power increases, carbon content increases and PVDF is carbonizes, and shows that the peaks, which increases in C═C as IPL power increases, indicates that IPL carbonizes PVDF binders.

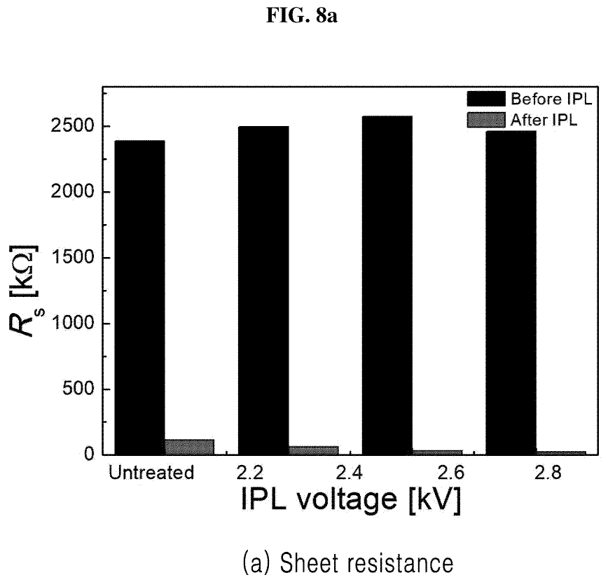

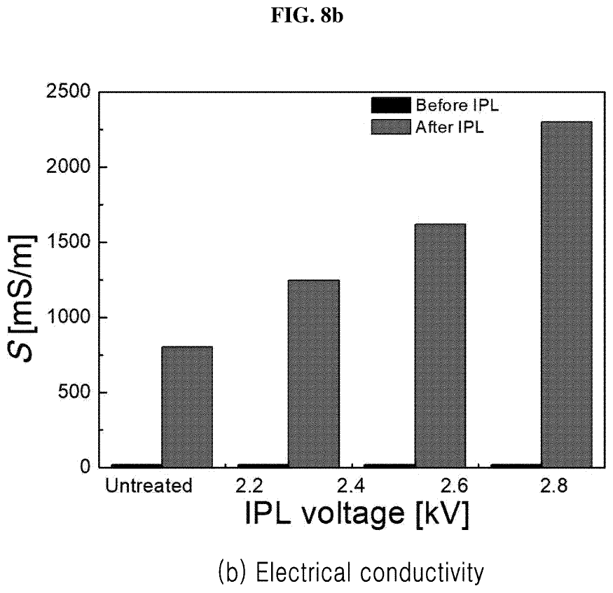

FIGS. 8a and 8b show (a) sheet resistance and (b) electrical conductivity, based on application of increasing power of IPL from 2.2 kV to 2.8 kV.

The carbonization of PVDF and the de-functionalization of acid modified carbon nanotubes significantly increased electric properties of the surface of a PVDF-CNT sample electrode. Average sheet resistance of the film was 2,458 kΩ/sq before the IPL treatment. As IPL voltage increased from 2.2 kV to 2.8 kV, the sheet resistance decreased to 112.5 kΩ/sq, 61.58 kΩ/sq, 31.9 kΩ/sq, and 21.8 kΩ/sq respectively, and a maximum decrease rate of the sheet resistance was 99.11%. In comparison between IPL voltage-based sheet resistance and IPL voltage-based electrical conductivity, electrical conductivity improved more significantly than sheet resistance. Average electrical conductivity was 20.5 mS/m before the IPL treatment. As IPL voltage increased, the electrical conductivity gradually increased to 805.2 mS/m, 1246.1 mS/m, 1619.4 mS/m, and 2299.8 mS/m respectively, and a maximum increase rate was 10,997%.

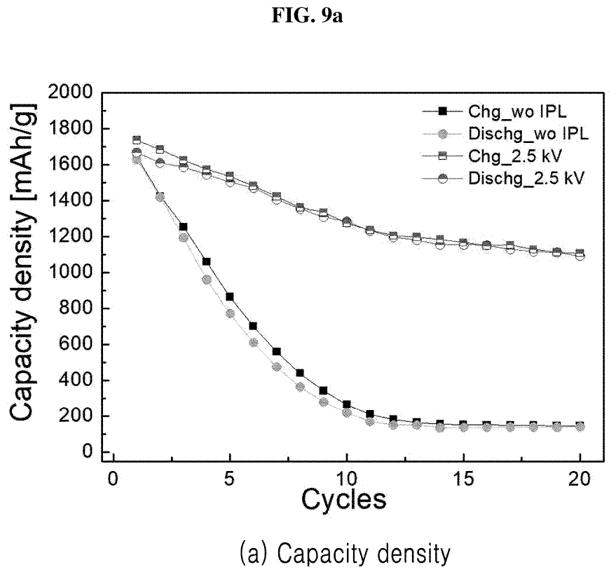

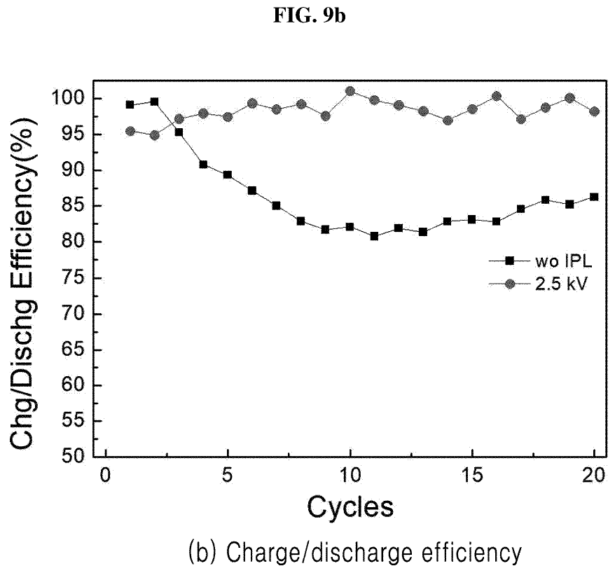

FIG. 9a shows results of comparison of the electrical capacitance of half cells before and after IPL application. Silicon was used as an active material, MWCNTs were used as a carbon material, and CMC and SBR at a ratio of 1:1 were used as a binder. A ratio among the active material, the acid modified carbon nanotubes, and the binder was 72:8:20. The performance of batteries was evaluated at a fixed 0.1 C-rate within a voltage range of 0.01-1.5 V in 20 cycles. In the first cycle, the discharge capacity density of an IPL-non-applied battery was about 1610 mAh/g, and the discharge capacity density of a 2.5 kV-IPL-applied battery was about 1780 mAh/g. Accordingly, the IPL treatment resulted in a 10% increase in the discharge capacity density. After 20 cycles, there was a big difference in the discharge capacity density before and after IPL application. The discharge capacity density of the IPL-non-applied battery was about 150 mAh/g while the discharge capacity density of the IPL-applied battery was 1180 mAh/g. The figure of the IPL-applied battery is about 7.8 higher than the figure of the IPL-non-applied battery. As shown in FIG. 9a, as the number of the cycles increased, the capacity density of the IPL-non-applied battery rapidly decreased, and the capacity density of the IPL-applied battery gradually decreased. Further, as shown in the results of efficiency of electric charge and discharge of FIG. 9b, the efficiency of the IPL-non-applied battery was maintained at about 99% until the second cycle, and as the number of the cycles increased, decreased to 80%, while the efficiency of the IPL-applied battery did not decrease and was maintained at 95% or greater despite an increase in the number of the cycles. The improvement was made because an even SEI layer was formed around the active materials via the carbonization of the binders during charge and discharge.

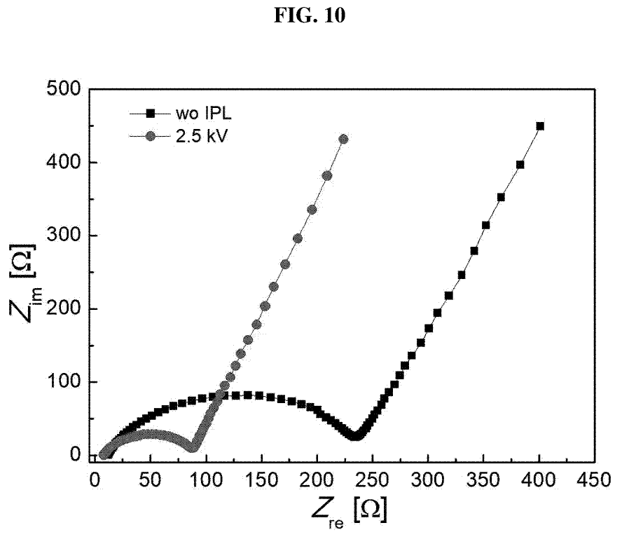

FIG. 10 shows results of electrochemical impedance spectroscopy before and after IPL application on electrodes. The electric charge-delivery resistance of a battery before IPL application was about 250Ω, the electric charge-delivery resistance of a 2.5 kV-IPL-applied battery was about 100Ω. The charge-delivery resistance decreased by about 60%. Additionally, before and after IPL application, diffusion resistance decreased from about 400Ω to about 200Ω which decreased by 50%. This resulted from improvement in the electrical conductivity among the active materials via de-functionalization of acid modified carbon and improvement in the movement of electric between the active material and the via the carbonization of the binders.

The subject matter of the present disclosure can be summarized as follows:

Provided is a method of improving electrochemical properties of an electrode applicable to an electrode of a lithium battery such as a lithium-ion battery, a lithium-metal battery, a lithium-air battery, a lithium-sulfur battery, or a lithium solid-state battery,
a. the electrode is an anode and/or a cathode including active materials, carbon additives and polymer binders,
b. the carbon additives are chemically functionalized or mixed with surfactants, to ensure improvement in dispersion,
c. the carbon additives, chemically functionalized or mixed with surfactants, are de-functionalized via application of energy, thereby improving their electrical conductivity, or metal impurities of the carbon additives are oxidized, thereby deactivating themselves,
d. the polymer binders are carbonized via the application of energy, thereby further increasing their electrical conductivity, or based on an increase in the amorphous phase or the beta phase of the crystalline binders, properties such as the ionic conductivity of the binder improve.

In the method in which carbon additives of high electrical conductivity are added to an anode or a cathode comprised of active materials and binders to increase electrical conductivity, the carbon additives may include carbon nanotubes such as multi-walled, single-walled, or thin-walled carbon nanotubes, graphene, graphene nanoplatelets, graphene oxides, carbon nanofibers, or graphite.

In the method in which carbon additive materials are dispersed using chemical functionalization, to achieve maximum electrical conductivity, the carbon additives are dispersed evenly among electrode layers. To disperse the carbon additives that inherently agglomerate, a chemical functionalization technique using acid and/or urea is utilized. Via the chemical functionalization, functional groups (carboxylic groups, amine groups etc.) attached to the carbon additives push away each other, thereby improving dispersion.

In the method in which carbon additive materials are dispersed using surfactants, to cause non-covalent physical functionalization of the carbon additives, the surfactants include, but are not limited to, one or more of alkylphenol polyoxyethylene ether (APEO), silane-modified polycarboxylate (silane-PCE), cationic polycarboxylate (C-PCE), Triton X-100™, Tween-20™ sodium dodecyl sulfate (SDS), and sodium dodecylbenzenesulfonate (SDBS).

In the method in which carbon additive materials are dispersed through a physical means, the carbon additives, either chemically functionalized or mixed with surfactants, are dispersed in an electrode mixture slurry, using ball milling or sonication at an ultrasonic frequency, and then dried for fixation of the dispersed state.

In the method in which high electrical conductivity is recovered, the chemically functionalized carbon additive materials are de-functionalized using instantaneous energy application of IPL after the fixation of the dispersed state.

In the method in which polymer binder materials are carbonized to improve properties of electrodes, polymer binders include, but are not limited to, one or more of polyacrylonitrile(PAN), polytetrafluoroethylene (PTFE), poly(methyl methacrylate) (PMMA), poly(3,4-ethylenedioxythiophene) polystyrene sulfonate (PEDOT:PSS), polydiacetylenes (PDAs), polypropylene, polystyrene (PS), polyurethane (PU), polyethylene oxide (PEO), polyethylene terephthalate (PET), styrene-ethylene-butylene-styrene (SEBS), glycerol, sucrose, cellulose, lignin, mesophase pitch, polyvinylidene fluoride (PVDF), polyvinylidene fluoride trifluoroethylene (PVDF-TRFE), and parylene-C. As the binders and the surfactants are carbonized, their electrical conductivity increases, and the hydrophilicity of electrodes also increases, enhancing the absorption of electrolytes.

In the method in which surfactants remaining in electrode composites are carbonized, using instantaneous energy application of IPL, to improve properties of electrodes, surfactants include, but are not limited to, one or more of alkylphenol polyoxyethylene ether (APEO), silane-modified polycarboxylate (silane-PCE), cationic polycarboxylate (C-PCE), triton X-100™ sodium dodecyl sulfate (SDS), and sodium dodecylbenzenesulfonate (SDBS), using instantaneous energy application method of IPL. As the binders and the surfactants are carbonized, their electrical conductivity increases, and the hydrophilicity of electrodes also increases, enhancing the absorption of electrolytes.

In the method in which metal impurities such as iron are oxidized, using instantaneous energy application of IPL, to improve properties of electrodes, even in vacuum or in an environment filled with inert gas, applied energy oxidizes metallic impurities using oxygen released from the surfactants and the polymer binders through carbonization.

In the method in which semi-crystalline polymer binders become more amorphous, using instantaneous energy application of IPL, at high intensity, to improve properties of electrodes, semi-crystalline polymer binders include, but are not limited to, one or more of PET, PTFE, PVDF and PVDF-TRFE. Semi-crystalline polymer binders have a high percentage of crystalline phases inhibiting ionic conductivity of binder materials. High-intensity energy application can decrease the crystalline phases and increase the amorphous PVDF for an increase in the ionic conductivity.

In the method in which semi-crystalline polymer binders are annealed and a beta-transition of polymeric chains is induced, using instantaneous energy application of IPL, at low intensity in repeated cycles, to improve properties of electrodes, semi-crystalline polymer binders include, but are not limited to, one or more of PET, PTFE, PVDF and PVDF-TRFE. While crystallinity of the polymers decreases the ionic conductivity of the materials, it could change surface characteristics to enhance electrolyte diffusion into electrodes.

In the method in which after the fixation of the dispersed state, carbon additive materials are de-functionalized using one or more of energy application methods of laser, microwaves or Joule heating, to traverse energy through thicker electrodes, thereby improving properties of electrodes, chemically functionalized carbon additive materials are de-functionalized to recover high electrical conductivity.

In the method in which polymer binders are carbonized using one or more of energy application methods of laser, microwaves or Joule heating, to traverse energy through thicker electrodes, thereby improving properties of electrodes, polymer binders include, but are not limited to, one or more of polyacrylonitrile (PAN), polytetrafluoroethylene (PTFE), poly(methyl methacrylate) (PMMA), poly(3,4-ethylenedioxythiophene) polystyrene sulfonate (PEDOT:PSS), polydiacetylenes (PDAs), polypropylene, polystyrene (PS), polyurethane (PU), polyethylene oxide (PEO), polyethylene terephthalate (PET), styrene-ethylene-butylene-styrene (SEBS), glycerol, sucrose, cellulose, lignin, mesophase pitch, polyvinylidene fluoride (PVDF), polyvinylidene fluoride trifluoroethylene (PVDF-TRFE), and parylene-C. As the binders and the surfactants are carbonized, their electrical conductivity increases, and the hydrophilicity of electrodes also increases, thereby enhancing absorption of electrolytes.

In the method in which surfactants remaining in electrode composites are carbonized using one or more of energy application methods of laser, microwaves or Joule heating, to traverse energy through thicker electrodes, thereby improving properties of electrodes, surfactants include, but are not limited to, one or more of alkylphenol polyoxyethylene ether (APEO), silane-modified polycarboxylate (silane-PCE), cationic polycarboxylate (C-PCE), triton X-100™, sodium dodecyl sulfate (SDS), and sodium dodecylbenzenesulfonate (SDBS). As the binders and the surfactants are carbonized, their electrical conductivity increases, and the hydrophilicity of electrodes also increases, thereby enhancing absorption of electrolytes.

In the method in which metal impurities such as iron are oxidized, using one or more of energy application methods of laser, microwaves, or Joule heating, to traverse energy through thicker electrodes, thereby improving properties of electrodes, even in vacuum or in an environment filled with inert gas, applied energy oxidizes metallic impurities using oxygen released from the polymer binders and the surfactants through carbonization.

In the method in which semi-crystalline polymer binders become more amorphous, using one or more of energy application methods of laser, microwaves, or Joule heating, to traverse energy through thicker electrodes, thereby improving properties of electrodes, semi-crystalline polymer binders include, but are not limited to, one or more of PET, PTFE, PVDF and PVDF-TRFE. Semi-crystalline polymer binders have a high percentage of crystalline phases inhibiting ionic conductivity of binder materials. High-intensity energy application can decrease the crystalline phases and increase the amorphous PVDF for an increase in the ionic conductivity.

An apparatus for enhancing material properties of electrodes includes a roll-to-roll machine with two rollers to which different electric potentials are applied, a thermal heater and a vacuum generator. The apparatus can control mechanical stress via the roll-to-roll machine and the vacuum generator, temperature via heater, and an electric field via an electrical potential applied between the two rollers. The apparatus can enhance material properties in the following ways:
a. semi-crystalline polymer binders are thermally treated to induce a beta-phase transition,
b. semi-crystalline polymer binders are electrically poled to induce a beta-phase transition,
c. carbon additive materials are aligned to be in parallel with an electrode plane using heat and compression,
d. carbon additive materials are aligned to be perpendicular to an electrode plane by applying vacuum pressure, and
e. carbon additive materials are aligned to be perpendicular to an electrode plane using an electric field or a magnetic field applied between the two rollers.

In the method in which a beta-phase transition of semi-crystalline polymer binders is induced by thermal treatment using the apparatus, heat applied to an electrode material decreases viscosity, and compression applies mechanical stress to form a more compact and organized crystalline structure.

In the method in which a beta-phase transition of semi-crystalline polymer binders is induced by electrical poling using the apparatus, a difference in the electric potential applied between the two rollers determines α phase transition ratio of the semi-crystalline polymer binders.

In the method in which carbon additives in electrodes are aligned by compression applied using the apparatus, when an electrode material proceeds between the two rollers, heat decreases viscosity of the material, and the compression applied by the rollers induces a radial shear flow, thereby inducing alignment of carbon additive materials in a direction parallel to an electrode plane, following the shear flow. The viscosity of the electrode material, the temperature, the amount of roller pressure and vacuum generated can determine a degree of alignment.

In the method in which carbon additives in electrodes are aligned by applying vacuum using the apparatus, when an electrode material proceeds between the two rollers, heat decreases viscosity of the material, and vacuum applied from the top and bottom of an electrode induces a shear flow of the material to induce alignment of carbon additive materials in a direction parallel to an electrode plane, following the shear flow. The viscosity of the electrode material, the temperature, the amount of roller pressure and vacuum generated can determine a degree of alignment.

In the method in which carbon additives in electrodes are aligned by an electric field or a magnetic field applied using the apparatus, when an electrode material proceeds between the two rollers, an electric field generated by AC or DC, or a magnetic field generated by an electromagnet or a permanent magnet induces alignment of carbon additives. The carbon additives may be pristine, chemically functionalized or physically decorated with magnetic materials such as iron oxide, cobalt to enhance a degree of the alignment. The viscosity of the electrode material, geometry of the carbon additives, intensity of the applied electric or magnetic field, and a frequency of the applied electric or magnetic field can determine a degree of alignment.

1. A method of manufacturing a lithium battery electrode, comprising:
(a) mixing active materials, carbon additives, and polymer binders and forming a slurry mixture;
(b) depositing the slurry mixture on a substrate and forming a coating;
(c) drying the coating; and
(d) applying energy to the dried coating,
wherein the carbon additives in (a) are chemically functionalized or mixed with surfactants, and
the carbon additives are de-functionalized or the surfactants are carbonized, as a result of the application of energy in (d).

2. (canceled)

3. The method of claim 1, wherein the polymer binders are carbonized as a result of the application of energy in (d).

4. The method of claim 1, wherein as a result of the application of energy in (d), at least a portion of the polymer binders is amorphized or a crystalline phase of at least a portion of the polymer binder changes.

5. (canceled)

6. (canceled)

7. The method of claim 1, wherein intense pulsed light (IPL) is used in (d).

8. The method of claim 1, wherein one or more of laser, microwaves, plasma or Joule heating are used in (d).

9. The method of claim 1, wherein the carbon additives comprise one or more of carbon nanotubes, graphene, grapheme oxides, graphene nanoplatelets, carbon nanofibers, and graphite.

10. The method of claim 1, wherein the method further comprises calendaring using two rollers after (c).

11. The method of claim 10, wherein different electric potentials are applied to the two rollers.

12. The method of claim 10, wherein in the calendaring step, mechanical, electric or magnetic poling is performed to align carbon additives in a direction parallel with a substrate or perpendicular to a substrate.

13. The method of claim 10, the calendaring step, comprising one or more of the following steps:
a. thermally treating semi-crystalline polymer binders and inducing a beta-phase transition;
b. electrically poling semi-crystalline polymer binders and inducing a beta-phase transition;
c. aligning carbon additives to be in parallel with an electrode plane by using heat and compression;
d. aligning carbon additives to be perpendicular to an electrode plane by applying vacuum pressure; and
e. aligning carbon additives to be perpendicular to an electrode plane by using an electric field or a magnetic field applied between the two rollers.

14. A method of manufacturing a lithium battery electrode, comprising:
(a) mixing active materials, carbon additives, and polymer binders and forming a slurry mixture;
(b) depositing the slurry mixture on a substrate and forming a coating;
(c) drying the coating; and
(d) applying energy to the dried coating,
wherein as a result of the application of energy in (d), metal impurities included in the dried coating are oxidized.

15. The method of claim 14, wherein the polymer binders are carbonized as a result of the application of energy in (d).

16. The method of claim 14, wherein as a result of the application of energy in (d), at least a portion of the polymer binders is amorphized or a crystalline phase of at least a portion of the polymer binder changes.

17. The method of claim 14, wherein the application of energy in (d) is performed in a vacuum atmosphere or an inert gas atmosphere, and
oxygen, released from the surfactants or the polymer binders upon the energy application, is used for the oxidation of metal impurities.

18. The method of claim 14, wherein intense pulsed light (IPL) is used in (d).

19. The method of claim 14, wherein one or more of laser, microwaves, plasma or Joule heating are used in (d).

20. The method of claim 14, wherein the method further comprises calendaring using two rollers after (c).

21. The method of claim 20, wherein different electric potentials are applied to the two rollers.

22. The method of claim 20, wherein in the calendaring step, mechanical, electric or magnetic poling is performed to align carbon additives in a direction parallel with a substrate or perpendicular to a substrate.

23. The method of claim 20, the calendaring step, comprising one or more of the following steps:
a. thermally treating semi-crystalline polymer binders and inducing a beta-phase transition;
b. electrically poling semi-crystalline polymer binders and inducing a beta-phase transition;
c. aligning carbon additives to be in parallel with an electrode plane by using heat and compression;
d. aligning carbon additives to be perpendicular to an electrode plane by applying vacuum pressure; and
e. aligning carbon additives to be perpendicular to an electrode plane by using an electric field or a magnetic field applied between the two rollers.
